(19) United States
(12) Patent Application Publication
(10) Pub. No.: US 2006/0178284 A1
(43) Pub. Date: Aug. 10, 2006

(54) Method for stabilizing percarboxylic acids in dispersions containing surfactants

(76) Inventors: Peter Schmiedel, Duesseldorf (DE); Heinz-Juergen Voelkel, Langenfeld (DE); Thomas Plantenberg, Mettmann (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/299,794

(22) Filed: Dec. 12, 2005

Related U.S. Application Data
(63) Continuation of application No. PCT/EP04/06166, filed on Jun. 8, 2004.

(30) Foreign Application Priority Data
Jun. 13, 2003 (DE) DE 103 27 127.9
Dec. 22, 2003 (DE) DE 103 61 081.2

(51) Int. Cl. C11D 3/39

(52) U.S. Cl. 510/310

(57) ABSTRACT

A method for stabilizing particulate peroxycarboxylic acids, in particular imidoperoxycarboxylic acids, (such as, e.g., PAP), which are solid at an ambient temperature in a preferably aqueous dispersion containing surfactants. The dispersion is established in such a way that in the dispersed state a degradation of the peroxycarboxylic acids in the dispersion is prevented or at least reduced or retarded, or that the solubility of the peroxycarboxylic acids in the dispersion is diminished, in particular by minimizing the halide ion content, reducing the pH value to pH values ≦7, minimizing the content of free or active surfactants, minimizing the content of non-ionic surfactants, adding complexers, adding catalases or adding a solvent with a low solubility capability for peroxycarboxylic acids etc.

### CROSS-REFERENCE TO RELATED APPLICATIONS

This application is a continuation under 35 U.S.C. § 365(c) and 35 U.S.C. § 120 of international application PCT/EP2004/006166, filed Jun. 8, 2004. This application also claims priority under 35 U.S.C. § 119 of DE 103 27 127.9, filed Jun. 13, 2003, and of DE 103 61 081.2, filed Dec. 22, 2003, each of which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to a process for stabilizing percarboxylic acids, particularly imidopercarboxylic acids, which are solid at room temperature, in dispersions containing surfactants, preferably aqueous dispersions, as well as the dispersions containing surfactants that are obtained in this way and their use in washing and cleaning agents, tooth-care products, hair colorants and decolorizing or bleaching agent compositions for technical uses. Furthermore, the present invention relates to washing and cleaning agents, tooth-care products, hair colorants and decolorizing or bleaching agent compositions particularly for technical uses, which comprise the stabilized surfactant-containing dispersions of percarboxylic acids.

For liquid, particularly aqueous washing and cleaning agents that are enjoying an increased popularity due to their positive product properties such as a better and faster solubility and practicality, the addition to the formulation or incorporation of bleaching (agent) components is problematic for numerous reasons. Due to their decomposition reactions or hydrolysis and incompatibilities towards other constituents of the washing agent formulation, such as, e.g., enzymes or surfactants, the added bleaching agents often lose their activity already on storage or even during product utilization. An adverse consequence resulting from this is that the washing performance—particularly the bleaching power—of the washing agent formulation noticeably deteriorates, such that bleachable stains in particular can no longer be satisfactorily removed.

Bleaching agents, such as, for example, perborates or percarbonates, which are usually used in solid washing agent formulations, are moisture sensitive, with the result that they often lose their bleaching power within a few days in a liquid and particularly aqueous washing or cleaning agent, due to the loss of active oxygen.

On the other hand, percarboxylic acids, especially imidopercarboxylic acids, the most important representative of which is phthalimidopercaproic acid (PAP), are more efficient and less sensitive to hydrolysis and are known in the prior art as bleaching agents for washing and cleaning agents. Nevertheless, their storage stability is by far insufficient to guarantee a long-term use of the corresponding washing and cleaning agent without the consequent loss in activity. The addition of percarboxylic acids, particularly imidopercarboxylic acids, in liquid washing and cleaning agents is therefore particularly problematic.

Because of the disadvantages that result from a modification of the washing and cleaning agent formulation as a consequence of the decomposition of imidopercarboxylic acids, particularly PAP, attempts have been made in the prior art to modify the washing and cleaning agents that contain imidopercarboxylic acids (e.g., PAP), such that the imidopercarboxylic acid in these formulations has a greater stability or storage stability.

(2) Description of Related Art including Information Disclosed under 37 C.F.R. §§ 1.97 and 1.98

Therefore, an aim of the prior art has been to stabilize these percarboxylic acids by putting a protective shell layer onto the percarboxylic acids in order to prevent any contact with the aqueous dispersion. However, the layered shell systems, known from the prior art, are often not sufficiently compatible with the dispersion medium and do not always provide the necessary stabilization. For example, certain shell materials can be dissolved over time by the dispersion medium. Other shell layer materials, particularly waxes having high melting points, (see EP 0 510 761 B1 and U.S. Pat. No. 5,230,822) have the disadvantage that they only release the enveloped or encapsulated percarboxylic acids at relatively high temperatures—and mostly without a delay—and in addition leave insoluble residues behind.

On the other hand, in the prior art, attempts have been made to adjust the dispersion medium for the percarboxylic acids so as to stabilize the percarboxylic acids. The measures known from the prior art, however, are not sufficient to adequately stabilize the percarboxylic acids in the presence of surfactants.

Thus, EP 0 334 405 B1 describes aqueous bleaching agent compositions containing solid, particulate, essentially water-insoluble, organic percarboxylic acids, wherein 1 to 30 wt. % of a secondary C₈-C₂₂ alkane sulfonate and 0.5 to 10 wt. % of a fatty acid are added to stabilize the percarboxylic acid against phase separation from the aqueous liquid. Due to the very specific composition of the additives, such a bleaching agent composition is not generally applicable. Moreover, the resulting stabilizing effect is not always adequate.

In a similar way, it was also attempted in EP 0334404 B1 to stabilize the percarboxylic acid against phase separation from the aqueous liquid. However, the percarboxylic acids could not be sufficiently stabilized against decomposition.

Overall, no efficient measures are disclosed in the prior art for an adequate stabilization of percarboxylic acids in aqueous dispersions.

### BRIEF SUMMARY OF THE INVENTION

Against this background, an object of the present invention therefore consists in providing surfactant-containing dispersions of percarboxylic acids, particularly imidopercarboxylic acids, such as phthalimidopercaproic acid (PAP), which possess a high storage stability, as well as to specify an appropriate manufacturing process for these dispersions.

A further object consists in providing storage stable, surfactant-containing dispersions of percarboxylic acids, particularly imidopercarboxylic acids, such as phthalimidopercaproic acid (PAP), with improved properties compared with the prior art, as well as an appropriate manufacturing process for these dispersions.

Another further object of the present invention is the provision of surfactant-containing dispersions that comprise solid, particulate percarboxylic acids and which lead to a good stabilization of the percarboxylic acid and hence to an improved storage stability. In particular, in the scope of the present invention, it is intended to provide dispersions that, inter alia, can be used for washing or cleaning agents, tooth-care products, hair colorants and decolorizing or bleaching agent compositions, particularly for technical uses or the like, or can be incorporated inter alia in washing or cleaning agents, tooth-care products, hair colorants and decolorizing or bleaching agent compositions, particularly for technical uses or the like. For this, the percarboxylic acids present in the dispersions should possess firstly, a high storage stability in the state of the concentrated dispersion, and secondly, on use of the product, particularly when diluted with water (e.g., during the washing process), possess a high active power or develop the entire bleach activity.

In this context, it can be frequently observed that percarboxylic acids, particularly PAP, when added in liquid, particularly aqueous media in the presence of surfactants, such as, for example, in washing and cleaning agent compositions, often in large amounts e.g., from 0.5 to 30 wt. %, particularly 5 to 30 wt. %, are rapidly decomposed, such that their use in surfactant-containing liquids, particularly aqueous media is of only very limited possibility.

Applicants have now surprisingly found that organic percarboxylic acids, particularly imidopercarboxylic acids (e.g., PAP), can be incorporated into surfactant-containing media or dispersions with a long storage stability, if they possess specific stabilizing properties, such as will be mentioned below in detail.

The object of the present invention, according to a first aspect, is therefore a process for stabilizing solid percarboxylic acids, particularly imidopercarboxylic acids, in a dispersion containing surfactants, preferably an aqueous dispersion, wherein the surfactant-containing dispersion is adjusted in such a way that a decomposition of the percarboxylic acid present in the surfactant-containing dispersion is prevented or at least reduced or retarded in the dispersion or the solubility of the percarboxylic acid in the dispersion is reduced.

According to the invention, the term “surfactant-containing dispersion” is particularly understood to mean a liquid, particularly aqueous system or medium that has a significant surfactant content (e.g., from 0.5 to 30 wt. %, particularly 5 to 30 wt. %, based on the dispersion or the continuous dispersion phase), as is required in e.g., washing and cleaning agents. In particular, the term “surfactant-containing dispersion” is understood to mean such a composition that in the context of its end-use disposes of an adequate surfactant content such that, e.g., the composition provides a washing or cleaning agent action.

The inventive process enables percarboxylic acids (e.g., PAP) in liquid, particularly aqueous dispersions or media to be efficiently stabilized in the presence of surfactants or their decomposition in such media to be efficiently minimized; this permits their use in such systems. Without these appropriate measures, percarboxylic acids (e.g., PAP) are unstable in liquid, particularly aqueous dispersions or media and are rapidly decomposed, such that their use in surfactant-containing liquid, particularly aqueous media was not possible up to now or was at the most of very limited possibility.

The percarboxylic acids, particularly imidopercarboxylic acids, used in the context of the present invention are those that are in the form of solid grains or particles at room temperature (20° C.) and normal or atmospheric pressure (101 325 Pa), i.e. are particulate.

For the purposes of the present invention, the term “decomposition” is understood to mean particularly chemical and/or physical decomposition processes or decomposition reactions of the percarboxylic acid, particularly chemical decomposition processes or decomposition reactions, such as hydrolysis, reduction, oxidation, disintegration etc. Such reactions lead to an irreversible decomposition or to a disintegration of the percarboxylic acids and hence to an impairment of their applicability, particularly an impairment of the bleaching performance of dispersions of such percarboxylic acids.

Applicants have now surprisingly found that a decomposition of percarboxylic acids, particularly imidopercarboxylic acids (e.g., PAP), in surfactant-containing dispersions, particularly surfactant-containing, aqueous dispersions, can be efficiently impeded or at least significantly minimized or reduced when the halide content of these dispersions is minimized, in particular when these dispersions are essentially free of or at least poor in halides, particularly chloride and/or bromide.

Applicants have surprisingly found that a high halide, especially chloride or bromide ion concentration, as is commonly found in conventional washing and cleaning agents, leads to an increased decomposition of percarboxylic acids. Therefore, a reduction in the halide, especially chloride or bromide ion concentration, can lead to a reduced decomposition of the percarboxylic acid in the (concentrated) dispersion. Consequently, a reduction or minimization of the halide ion concentration leads to a drastic decrease in decomposition or a significant stabilization of the solid particulate percarboxylic acids present in the dispersion.

### BRIEF DESCRIPTION OF THE SEVERAL VIEWS OF THE DRAWINGS

Not Applicable

### DETAILED DESCRIPTION OF THE INVENTION

The percarboxylic acids in the dispersion are particularly well stabilized when the total content of halide ions, particularly chloride and/or bromide, based on the continuous dispersion phase, does not exceed 100 ppm, particularly 50 ppm, preferably 30 ppm, particularly preferably 15 ppm (i.e. the total quantity of halides by weight in the continuous phase of the dispersion C_{halide(total)} is ≦100 ppm, particularly ≦50 ppm, preferably ≦30 ppm, particularly preferably ≦15 ppm). According to the invention, the abovementioned amounts are understood to mean essentially halide-free or halide-poor ranges or amounts. According to the invention, the term “continuous phase of the dispersion” is understood to mean the dispersion agent with the components or ingredients (e.g., salts, surfactants etc.) dissolved therein. According to the invention, the preferred dispersion agent is water.

The minimization of the halide ion content carried out in the context of the present invention, particularly the chloride and bromide content, in the inventive dispersion can be achieved by choosing or avoiding certain ingredients, components etc. (e.g., the use of essentially halide-free components, thus halide-free surfactants, halide-free phosphonates etc.). According to the invention, a low halide, particularly chloride ion concentration can be achieved, for example, by the addition of halide-free cationic surfactants, e.g., in the form of compounds of methyl sulfate, phosphate, tosylate or cumene sulfonate. On the other hand, many technical components of detergents contain sometimes non-negligible concentrations of chloride or bromide, in particular technical qualities of anionic surfactants may be cited. Therefore, according to the invention preferably only those detergent components—particularly surfactants—should be selected that have at least essentially no halide or chloride ions and only those raw materials with a particularly low halide or chloride content.

In general, the additional components, which are used in the inventive process for manufacturing the dispersions, should be chosen with the proviso that they are firstly essentially halide-free or at least halide-poor and secondly that they are at least largely compatible with respect to the percarboxylic acids, i.e. there should be no unwanted chemical reactions, such as degradation, in particular reduction or oxidation and/or hydrolytic reactions between these components and the percarboxylic acid and none induced by the additional components on the percarboxylic acid that would lead to its loss in activity, in particular to its decomposition.

Applicants have now surprisingly found that the stabilizing effect, achieved by minimizing the halides, can even be increased with respect to the percarboxylic acids present in the surfactant-containing dispersion by adjusting the surfactant-containing dispersion to acidic, preferably weakly to slightly acidic or if need be neutral. Preferably the dispersion is adjusted to a pH of maximum 7, particularly a pH of 3.5 to 7, preferably from 4.0 to 6.5, particularly preferably from 4.5 to 6, quite particularly preferably of about 5.

Surprisingly, bleaching agents based on percarboxylic acids, such as PAP, can be efficiently stabilized in an acidic surfactant-containing environment, as the percarboxylic acids are only slightly soluble in the dispersion agent, particularly water, at such a pH and are present as crystal dispersions, whereas at neutral or alkaline pH a relatively rapid decomposition of the percarboxylic acids like PAP, takes place due to the increased solubility. Nevertheless, the pH of the dispersion, particularly of the washing or cleaning agent, should not be made too acidic in order to avoid a degradation or inactivation of any enzymes optionally present in the dispersion. Consequently, the pH value cited in the context of the present invention illustrates one of the optimized areas of this background.

The adjustment, particularly the reduction or shift of the pH of the dispersion into the acidic region, can be carried out in the context of the present invention with acids or acidic salts. Exemplary inventively suitable acids or acidic salts for adjusting the pH are e.g., organic polycarboxylic acids, bisulfates and biphosphates. Moreover, phosphonates used as chelating agents, can be incorporated as phosphonic acids and subsequently adjusted to the desired pH by the addition of alkalis (Process for adjusting the pH).

In addition, Applicants could surprisingly demonstrate that the stabilizing effect with respect to the percarboxylic acids present in the dispersion and obtained by use of the cited measures, can be further increased when the surfactants, present in the dispersion—as is the case for instance for washing and cleaning agents—are converted into an inactivated form, i.e. the dispersion should at least essentially comprise no surfactants in active form. The total active surfactant content in the dispersion or the continuous phase of the dispersion should be less than 5%, particularly less than 2.5%, preferably less than 1%, based on the dispersion or the continuous dispersion phase. In other words, the total inactivated surfactant content in the dispersion is more than 95%, particularly more than 97.5%, preferably more than 99%, based on the total surfactant.

In this context, Applicants were able to show that organic percarboxylic acids, particularly PAP, are rapidly decomposed in the presence of active surfactants (i.e. surfactants, present in free and/or micellar form in the washing or cleaning agent formulation), as the percarboxylic acids, due to the surfactants, are better dissolved and are extremely unstable in this dissolved state. In this context, non-ionic surfactants or niosurfactants, e.g., based on alkyl polyglycol ethers, lead to an accelerated decomposition of the percarboxylic acids. In the inventive process, the dispersion should therefore have an optimized, preferably a low non-ionic surfactant (niosurfactant)/charged surfactant ratio. Here, the alkyl polyglycol ether content should be as low as possible.

The surfactants can be inactivated by adding sulfates, particularly preferably sodium sulfate. This produces in particular, a salting out of the surfactants i.e. a phase separation is induced to form a surfactant-poor, continuous phase and a preferably lamellar, generally high viscosity crystalline or liquid-crystalline surfactant-rich phase) the surfactants being transported out of the particularly micellar, active form into a preferably lamellar, crystalline or liquid-crystalline form (crystal formation or liquid crystal formation) that is dispersed in an almost surfactant-free continuous phase. The dispersed surfactant liquid crystal, itself, which can be separated by centrifugation, for example, should be as highly viscous as possible. A particularly good stabilization of the percarboxylic acid can be obtained when the content of free surfactants in the inventive washing and cleaning formulations in the continuous phase is particularly preferably not more than 1%, based on the dispersion or the continuous phase of the dispersion.

Preferably, the surfactants can be inactivated by incorporating sodium sulfate into the continuous phase of the dispersion. For this, the sodium sulfate can be incorporated into the dispersion in amounts of 5 to 30 wt. %, particularly 15 to 30 wt. %, preferably 20 to 30 wt. %. According to the invention, the term “incorporate” is particularly understood to mean to dissolve the sodium sulfate incorporated into the dispersion, by dissociation or solubilization, for example.

Applicants have now unexpectedly found that a particularly good stabilization of the percarboxylic acid present in the dispersion is then obtained when all of the abovementioned measures are realized in the dispersion (i.e. minimization of the halide content, lowering the pH, inactivating the surfactants, optimized or minimized niosurfactant content). Surprisingly, the abovementioned measures act synergistically, resulting in a particularly efficient stabilization of the dispersed, solid particulate percarboxylic acids and consequently a good storage stability of such dispersions.

The inventive process for stabilizing percarboxylic acids, particularly imidopercarboxylic acids, which are solid at room temperature, in dispersions containing surfactants, preferably aqueous dispersions, can also, all in all, be carried out so as to adjust the dispersions in such a way,
that the total content of halide ions, particularly chloride and/or bromide, based on the continuous dispersion phase, does not exceed 100 ppm, particularly 50 ppm, preferably 30 ppm, particularly preferably 15 ppm; and/or
that the dispersion has a pH of maximum 7, particularly a pH of 3.5 to 7, preferably from 4.0 to 6.5, particularly preferably from 4.5 to 6, quite particularly preferably of about 5; and/or
that the dispersion, at least essentially, comprises no surfactants in active form, in particular wherein the total active surfactant content in the continuous phase of the dispersion is less than 5%, particularly less than 2.5%, preferably less than 1%, based on the continuous dispersion phase.

As Applicants have unexpectedly discovered, the stabilization of the percarboxylic acid in the inventive dispersions can be further increased when at least one chelating agent is added to the aqueous dispersion, preferably in amounts of 0 to 10 wt. %. The chelating agent, can be selected from the group of quinoline and/or its salts, alkali metal polyphosphonates, picolinic acid and dipicolinic acid, mono- or polyphosphonic acids, particularly 1-hydroxyethylidene-1,1-diphosphonic acid (HEDP), ethylene diamine tetraacetic acid (EDTA), diethylene triamine penta(methylenephosphonic acid) (DTPMP), azacycloheptane diphosphonate (AHP), nitrilotriacetic acid (NTA), citrate and/or short chain dicarboxylic acids. According to the invention, these chelating agents are particularly added to complex the heavy metal ions that act as catalysts for oxidation processes and can thereby lead to a decomposition of percarboxylic acids, such as PAP and which can be incorporated, for example, from water pipes or metallic components of the production units or from raw materials or ingredients into the inventive washing or cleaning agents.

In addition, in the scope of the inventive process, at least one catalase can be added to further increase the stabilization of the percarboxylic acids of the aqueous dispersion. Here, the catalase is used in particular to remove any hydrogen peroxide present or formed in the dispersion. Hydrogen peroxide may possibly form from the reaction of the percarboxylic acid with water; the addition of a catalase efficiently diminishes the hydrogen peroxide content in the dispersion, and thus any additional oxidation-sensitive ingredients, for example, enzymes are efficiently protected. With this objective, at least one peroxidase and/or at least one antioxidant, optionally in addition to the at least one catalase, can similarly be added to the inventive washing or cleaning agents. According to the invention, preferred antioxidants are e.g., ascorbic acid, tocopherol, gallic acid or their derivatives.

Moreover, Applicants have surprisingly discovered that the stability of the percarboxylic acids in the inventive surfactant-containing dispersions can be increased if in particular a water-miscible solvent (e.g., glycerin) is added to the dispersion or even the water-miscible solvent is the dispersion agent or the dispersion. The solvent should be a poor solvent for the organic percarboxylic acids, particularly imidopercarboxylic acids. This solvent is preferably glycerin. Preferably, the quantity of solvent (e.g., glycerin) can be more than 20 wt. %, particularly preferably more than 30 wt. %, based on the dispersion. For these solvent-based variants, the water content of the washing or cleaning formulations should be about 5 wt. % based on the dispersion, wherein the glycerin content can exceed 70 wt. %. Glycerin is a poor solvent for organic percarboxylic acids, particularly imidopercarboxylic acids and this can lead to a stabilization of the percarboxylic acid in the inventive dispersions. Consequently, the quantity of optionally added glycerin should be such that it does not negatively influence the additional ingredients, particularly concerning their solubility in the dispersion. Overall, water is the preferred dispersion agent, however.

To further increase the stability, in particular the storage stability of the percarboxylic acids in the inventive dispersions, the percarboxylic acids—in so far as is desired or required from the process or application points of view—can be additionally provided with at least one shell or be incorporated into at least one matrix, such that e.g., a capsule system results, having a capsule core based on at least one percarboxylic acid. For this inventive embodiment, the storage stability of the percarboxylic acids is increased by at least essentially preventing or at least diminishing a direct contact of the percarboxylic acid with the surroundings, in particular with the dispersion or the dispersion agent and the dissolved or dispersed substances therein.

For example, the shell or matrix can include or consist of at least one inorganic salt, preferably an inorganic sulfate, particularly preferably sodium sulfate. For a capsule system of this type, the inventive dispersion should be formed in such a way that during storage the sulfate shell is at least essentially not disintegrated, in particular dissolved away or dissolved, which can be accomplished particularly by adding a salt to influence the solubility of the shell, for example, an inorganic sulfate, particularly preferably sodium sulfate. A release of the percarboxylic acid should then occur during use, particularly in a washing liquor by corresponding dilution effects accompanied by disintegration of the shell.

Advantageously, the coating of the shell or matrix onto the percarboxylic acid occurs prior to incorporation into the dispersion. The shell or matrix, for example, can be a gel, based, for example, on an oil phase that was hardened or gelled by a stabilizer, particularly gel-formers. Moreover, in the scope of the inventive process, the shell can be a multi-layered polyelectrolyte capsule shell, for example. In addition, the shell or matrix can comprise, for example, inorganic salts, particularly sulfates and/or phosphates, inorganic oxides, organic polymers, particularly cellulose ethers, polyvinyl alcohols (PVA) and polyvinyl pyrrolidones (PVP).

By coating the percarboxylic acid with at least one shell or matrix, capsule systems are obtained that besides the capsule core based on percarboxylic acid, have a capsule shell based on the shell materials—as described below. In this way, both the capsule core as well as the capsule shell can possess additional substances for the adjustment of the capsule system properties, in the case that this is required or desired from process or application reasons. Thus, the organic percarboxylic acid can be coated with a substance that can undergo endothermic reactions with itself, in particular elimination of water of crystallization or decomposition reactions at a temperature below 80° C., particularly below 70° C. However, this substance can also be blended or mixed with the percarboxylic acid. For example, the substance can be boric acid. Moreover, the shell or matrix can comprise at least one chelating agent, particularly as defined above.

In addition, the rate of dissolution of the capsule system and therefore the release of the percarboxylic acids during usage, particularly in a washing liquor, can be adjusted as required, by coating a shell or matrix onto the percarboxylic acid. In this way, a “controlled release effect” with respect to the percarboxylic acids contained in the inventive capsule system can be achieved. A “controlled release effect” is particularly understood to mean a slightly delayed, preferably between 1 and 15 minutes, dissolution of the capsule system during usage, for example, on dilution in a washing or cleaning liquor, or a release of the percarboxylic acid from the capsule system.

The decomposition, particularly the dissolving away or the dissolution of the capsule shells during use of the dispersion (for example, in a washing liquor) generally results due to physical or chemical interactions or reactions, for example, solubilization or dissociation processes, particularly as a result of dilution effects in the wash liquor.

In the inventive process, the particle size of the organic percarboxylic acids incorporated into the dispersion can be ≦3000 μm, particularly ≦2500 μm, advantageously ≦2250 μm, preferably ≦2000 μm, particularly preferably 1500 μm. In this context, the particle size of the organic percarboxylic acids should be 10 to 3000 μm, particularly 50 to 2500 μm, preferably 100 to 1500 μm.

In the inventive process, the content of organic percarboxylic acids, particularly imidopercarboxylic acid, based on the dispersion, is 0.1 to 30 wt. %, particularly 0.5 to 25 wt. %, advantageously 1 to 20 wt. %, preferably 1 to 15 wt. %. According to the invention, the particle size of the solid percarboxylic acid particles can be adjusted before incorporating the percarboxylic acid particles into the dispersion using processes known to the expert, for example, by shearing, vibration and/or ultrasound, milling, grinding etc., such that a targeted match of particle size, corresponding to their later use, is possible.

A controlled adjustment or matching to the required product properties can be undertaken by selecting the particle size as well as the inorganic percarboxylic acid content in the dispersions.

In the inventive process, as in the inventive dispersion, organic percarboxylic acids are employed as the substances to be stabilized. The percarboxylic acids may be selected from organic mono or di percarboxylic acids. Particular examples are dodecanebis(peroxoic) acid or preferably imidopercarboxylic acids, particularly preferably 6-phthalimidopercaproic acid (6-phthalimidoperhexanoic acid, PAP). Advantageously the percarboxylic acid should have a melting point at atmospheric pressure (101 325 Pa) above 20° C., particularly above 25° C., in preference above 35° C., preferably above 45° C., particularly preferably above 50° C., quite particularly preferably above 100° C.; in this way it is assured that the percarboxylic acid used is mainly present as solid particles, such that a degradation of the percarboxylic acid in the inventive dispersion is at least reduced.

A further subject—according to a second aspect of the present invention—concerns the storage stable, surfactant-containing dispersions, particularly surfactant-containing aqueous dispersions of percarboxylic acids, particularly imidopercarboxylic acids that are solid at room temperature and manufacturable according to the inventive process. The inventive surfactant-containing dispersion is adjusted in such a way that a decomposition of the percarboxylic acid present in the state of the surfactant-containing dispersion is prevented or at least reduced or retarded or the solubility of the percarboxylic acid in the surfactant-containing dispersion is reduced.

An inventive, storage stable surfactant-containing dispersion can thus be adjusted in such a way
that the content of halide ions, particularly chloride and/or bromide, based on the continuous dispersion phase of the dispersion, does not exceed 100 ppm, particularly 50 ppm, preferably 30 ppm, particularly preferably 15 ppm; and/or
that the dispersion has a pH of maximum 7, particularly a pH of 3.5 to 7, preferably from 4.0 to 6.5, particularly preferably from 4.5 to 6, quite particularly preferably of about 5; and/or
that the dispersion, at least essentially, comprises no surfactants in active form, in particular wherein the total active surfactant content in the continuous phase of the dispersion is less than 5%, particularly less than 2.5%, preferably less than 1%, based on the continuous dispersion phase.

For further details concerning the inventive dispersions, reference can be made to the above statements on the inventive process, which are correspondingly valid for the inventive dispersions.

The inventive dispersions possess numerous application possibilities, thus—according to a further aspect of the present invention—they can be added into or as washing and cleaning agents, particularly liquid washing and cleaning agent compositions, tooth-care products, hair colorants or decolorizing or bleaching agent compositions for technical uses.

In this respect, the cited formulations or compositions exhibit a high storage stability with respect to the percarboxylic acids and thus dispose of a high activity, particularly bleaching activity, even after longer periods.

A further subject of the present invention—according to a further aspect of the present invention—are washing and cleaning agents, tooth-care products, hair colorants or decolorizing or bleaching agent compositions for technical uses, which comprise the inventive dispersions.

The inventive washing and cleaning agents can be used for cleaning hard surfaces and/or soft, especially textile surfaces. The inventive washing and cleaning agents can be used especially as dishwasher agents, general purpose cleaners, bath cleaners, floor cleaners, automobile cleaners, glass cleaners, furniture care agents or cleaners, facade cleaners, detergents or the like, particularly preferably as detergents. In addition, the inventive washing and cleaning agents are advantageously suited for cleaning fibers, textiles, carpets and the like.

The inventive washing and cleaning agents comprise, in addition to the inventive dispersions, usual ingredients or constituents known to the expert (e.g., surfactants, fragrances, colorants, enzymes, enzyme stabilizers, olfactory materials or olfactory builders, pH-adjusters, other bleaching agents, bleach activators, silver protection agents, soil repellents, optical brighteners, graying inhibitors, disintegration auxiliaries, thickeners, defoamers, chelating agents for heavy metals, soil repellents, color transfer inhibitors, solvents, optical brighteners and/or optional further usual ingredients), wherein in the context of the present invention, care should be taken concerning the compatibility of the individual ingredients or components, both among themselves as well as in regard to the inventive dispersions or the percarboxylic acids contained therein, and can be realized by judicious choices of ingredients or components and/or their relative proportions. In this manner, an unwanted interaction of the ingredients or components with the percarboxylic acids incorporated in the inventive dispersions can be avoided.

An inventive washing or cleaning agent, especially a liquid washing or cleaning agent, includes, for example, the following ingredients:
(i) at least one solid, particulate organic percarboxylic acid, particularly imidopercarboxylic acid, in amounts of 0.1 to 30 wt. %, particularly 0.5 to 25 wt. %, advantageously 1 to 20 wt. %, preferably 1 to 15 wt. %; and/or
(ii) surfactants, advantageously in inactivated form, particularly cationic and/or anionic surfactants, advantageously in amounts of 0 to 30 wt. %, and/or non-ionic surfactants, preferably in amounts of 0 to 30 wt. %; and/or
(iii) optional electrolytes, particularly inorganic and/or organic salts, particularly phosphate, citrate and/or sulfate, particularly preferably sodium sulfate, preferably in amounts of 5 to 30 wt. %; and/or
(iv) optional chelating agents, particularly selected from the group of quinoline and/or its salts, alkali metal polyphosphonates, picolinic acid and dipicolinic acid, mono- or polyphosphonic acids, particularly 1-hydroxyethylidene-1,1-diphosphonic acid (HEDP), ethylene diamine tetraacetic acid (EDTA), diethylene triamine penta(methylenephosphonic acid) (DTPMP), azacycloheptane diphosphonate (AHP), nitrilotriacetic acid (NTA), citrate and/or short chain dicarboxylic acids, preferably in amounts of 0 to 10 wt. %; and/or
(v) optional enzymes, such as proteases, amylases, cellulases and/or lipases, and/or enzyme stabilizers, preferably in amounts of 0 to 10 wt.%; and/or
(vi) optional builders, particularly fatty acids, preferably saturated and/or branched fatty acids, particularly with a melting point below 30° C., and/or citric acid and/or citrate, preferably in amounts of 0 to 15 wt. %; and/or
(vii) optional fragrances, preferably in amounts of 0 to 5 wt. %; and/or
(viii) optional auxiliaries, such as defoamers, pH regulators, rheology modifiers (thickeners), solvents, colorants; and/or
(ix) optional additional usual ingredients, such as brighteners etc.; and/or
(x) water;
   wherein all the specified weights are based on the washing or cleaning agent.

In general, the inventive washing or cleaning agent formulation should be designed in such a way that the stability of the percarboxylic acids, at least essentially, is not reduced. Thus, the components, which are used in the inventive washing or cleaning agent, should be chosen with the proviso that they are at least largely compatible with respect to the percarboxylic acids, i.e. particularly in the washing or cleaning agent itself, particularly in the period before its utilization (storage time), there should be no unwanted chemical reactions, such as in particular degradation, oxidation or reduction and/or hydrolytic reactions between these components and the gel capsules, which would lead to a premature decomposition and a loss in activity of the percarboxylic acids.

In the inventive washing and cleaning agents, particularly in liquid washing and cleaning agents, the surfactants in the washing and cleaning agent formulations should be inactivated, particularly by salting out, i.e. the induction of a phase separation into a surfactant-poor, continuous phase and a preferably lamellar, generally high-viscosity, crystalline or liquid-crystalline surfactant-rich phase, preferably by incorporating a sulfate compound, particularly preferably sodium sulfate, into the washing or cleaning agent formulation.

As illustrated above, the inactivation of the surfactants leads to an effective protection or to an increased stability of the percarboxylic acids. The free surfactant content in the inventive washing and cleaning agent formulations should be preferably not more than 1% in the continuous phase. In this context, an optimized or smallest possible niosurfactant/charged surfactant ratio should also be present in the inventive washing or cleaning agents—corresponding to the explanations of the inventive dispersion or the manufacturing process. Here, the alkyl polyglycol ether content should be as low as possible.

In addition, the content of inorganic salt, particularly preferably sodium sulfate in the washing or cleaning agent, should be chosen such that the surfactants in the washing or cleaning agent are at least essentially inactivated, particularly by salting out, advantageously by the introduction of a sulfate compound, particularly preferably sodium sulfate. The sulfate concentration in the inventive washing or cleaning agents should be chosen such that on using the washing or cleaning agent in the washing liquor, the surfactants are once more present in active form, which can be achieved, for example, through a dilution effect when the washing or cleaning agent is incorporated into the washing liquor. In particular, the concentration should be chosen such that—as previously mentioned—less than 1% of active surfactant is present in the continuous phase of the washing or cleaning agent and no sulfate crystallizes out on lowering the temperature, particularly down to 0° C.

The inventive washing and cleaning agent should have, at least essentially, no increased chloride or bromide ion content; this can be achieved by the addition of compounds of methyl sulfate, phosphate, tosylate or cumene sulfonate. Moreover, raw materials should be selected, which have a particularly low chloride or bromide content.

The inventive washing or cleaning agents can comprise at least one fatty acid. According to the invention, saturated and/or branched fatty acids, particularly with a melting point below 30° C., are preferred. In the context of the present invention, Isocarb-16® from the Sasol company, for example, can be used in the inventive washing or cleaning agents.

For further details concerning the inventive washing or cleaning agents, reference can be made to the above statements on the inventive process and the inventive dispersions.

In order to obtain an adequate bleaching power in the washing liquor, the inventive washing or cleaning agent or the inventive dispersions should be converted in such a way that the percarboxylic acids are activated or released sufficiently quickly. The activation or release of the percarboxylic acids results particularly from physical or physico-chemical or chemical processes. Thus, as the inorganic salt, particularly sodium sulfate, is diluted in the washing liquor, the surfactants are converted from their inactivated form (for example, surfactants present as liquid crystals) into the active, micellar form, such that the surfactants, activated in this way, can dissolve or solubilize the solid percarboxylic acids. The dilution in the washing liquor simultaneously causes a marked jump in the pH of the washing and cleaning agent that had been adjusted to be generally acidic, with the result that the solubility of the percarboxylic acid also markedly increases.

In addition, the washing or cleaning agent should be composed in such a way that it ensures a disintegration, in particular a dissolution or solubilization of an optional shell or matrix coated onto the percarboxylic acids—in particular as previously illustrated—during the application, particularly in the washing liquor. Thus, for example, dissolution of the optionally present sulfate shell can be achieved by means of the dilution effect addressed previously. Furthermore, an optionally present gel matrix can be dissolved or solubilized by activating the surfactants in the washing liquor. In this context, dissolution, particularly solubilization of an optional polyelectrolyte shell can also be supported or provoked by the activated surfactants. Mechanical forces also contribute here.

Compared with the prior art, the present invention exhibits a series of advantages:

The inventive dispersions lead to a significant increase in the storage stability of the percarboxylic acids incorporated therein—particularly in combination with a low chloride or bromide content—such that the efficiency of the percarboxylic acids, particularly the bleaching power, is also guaranteed over a prolonged period or after a lengthy storage time. In this way, in line with a synergistic effect, each of the measures or adjustments of the dispersion lead to a significant increase in storage stability of the percarboxylic acid in the dispersion.

The inventive process for manufacturing the dispersions is simple and well manageable, resulting in the avoidance of any addition of difficultly manufacturable and therefore expensive substances. Therefore the process is extremely suitable for use on a large industrial scale.

Due to the targeted adjustment of each property of the dispersion, in particular the chloride content, the inactivation of the surfactants, pH adjustment etc., firstly an exceptionally good stabilization of the percarboxylic acids is achieved, particularly in that an increased stability can be achieved due to the synergy resulting from the combination of these measures. Secondly, the inventive dispersions or washing and cleaning agents permit the percarboxylic acids to be released or activated on use, particularly in a washing liquor and therefore provide an outstanding washing power, particularly bleaching power to the appropriate formulation.

In addition, the composition and active substance content of the dispersions can be widely varied or tailor made such that particularly for washing and cleaning agents, an individual match to each requirement can be obtained. Due its specific formation, the dispersion can be almost universally used for various compositions over a wide field.

In addition, percarboxylic acids, which are equipped with a shell or matrix for additional stability, can also be incorporated into the inventive dispersions, i.e. the inventive dispersion is also compatible with such capsule systems.

Due to their adjusted and synergistically acting modifications on each other listed above, i.e. in particular a lower halide ion content, optimization of the pH, addition of chelating agents, inactivation of surfactants, use of specific solvents or enzymes, such as catalases or peroxidases, addition of antioxidants, the inventive washing and cleaning agent formulations possess substantial advantages compared with the prior art, as a decomposition of the sensitive bleaching agent based on percarboxylic acid is significantly reduced.

Further developments, modifications and variations as well as advantages of the present invention are directly recognizable and realizable by the expert on reading the description, without him thereby leaving the scope of the present invention.

The present invention is clarified by means of the following exemplary embodiments, which in no way, however, limit the invention.

### EXAMPLES

### Example 1

In this exemplary embodiment it is shown how the stability of PAP is impaired by chloride: A 3% aqueous dispersion of PAP (Eureco® W in distilled water) was treated with various concentrations of NaCl and stored at 40° C. The remaining fraction of PAP (in %) was determined after different times. This is depicted in the following TABLE:

| c(NaCl) (wt. %) | 0 | 0.03 | 0.1 | 0.3 | 1 | 3 | 10 |
|---|---|---|---|---|---|---|---|
| 1 day | 100 | 98 | 97.7 | 93 | 86 | 75.7 | 48 |
| 4 days | 97.7 | 94 | 86.8 | 76.7 | 51.7 | 12.5 | 7.3 |

An increased degradation with increasing chloride content is observed.

### Example 2

In this EXAMPLE it is shown that by adding raw materials—here technical surfactants—with inventive chloride levels, the stability of PAP can be significantly increased.

Solutions of the following composition were prepared:
1. Comparative EXAMPLE:

3% PAP

15% SDS, Texapon® K-12 (Cognis), chloride content ˜0.4% remainder water
2. Inventive

3% PAP

15% SDS, recrystallized, chloride content <1 ppm remainder water

The samples were stored at room temperature. The residual proportions of PAP are given in the following TABLE:

| | 3 days | 1 week |
|---|---|---|
| Comparative EXAMPLE: | — | 57.1 |
| Inventive | — | 93.3 |

1. A process for stabilizing percarboxylic acids, which are solid at room temperature, in a dispersion comprising surfactants, said process comprising the step of minimizing halide ion content in the dispersion, thereby reducing the decomposition and/or solubility of the percarboxylic acids in the dispersion.

2. The process for stabilizing percarboxylic acids according to claim 1, wherein the dispersion is adjusted in such a way
that the total content of halide ions, based on the continuous dispersion phase, does not exceed 100 ppm and/or
that the dispersion has a maximum pH of 7 and/or
that the dispersion comprises no surfactants in active form, in particular wherein the total active surfactant content in the continuous phase of the dispersion is less than 5%, based on the continuous dispersion phase.

3. The process according to claim 1, wherein at least one chelating agent, selected from the group consisting of quinoline and/or its salts, alkali metal polyphosphonates, picolinic acid and dipicolinic acid, mono- or polyphosphonic acids, 1-hydroxyethylidene-1,1-diphosphonic acid (HEDP), ethylene diamine tetraacetic acid (EDTA), diethylene triamine penta(methylenephosphonic acid) (DTPMP), azacycloheptane diphosphonate (AH)), nitrlotriacetic acid (NTA), citrate and/or short chain dicarboxylic acids is added to the dispersion in amounts of up to 10 wt. %.

4. The process according to claim 1, wherein the surfactants in the dispersion are more than 95 wt. % inactivated, based on the total surfactants, wherein the surfactants are converted into a preferably lamellar, liquid crystalline or crystalline form and/or are inactivated by salting out, by inducing a phase separation into a surfactant-poor, continuous phase and a lamellar, generally highly viscous, crystalline or liquid crystalline surfactant-rich phase, by incorporating sodium sulfate into the continuous phase of the dispersion, in amounts of 5 to 30 wt. % based on the continuous phase.

5. The process according to claim 1, wherein the percarboxylic acids are additionally provided with at least one shell or are deposited in at least one matrix, said shell or matrix comprising at least one organic salt.

6. The process according to claim 5, wherein the shell or matrix comprises at least one gel, based on an oil phase that was hardened and/or gelled by a stabilizer.

7. The process according to claim 5, wherein the shell is a multi-layered polyelectrolyte capsule shell.

8. The process according to claim 1, wherein the organic percarboxylic acids are the group consisting of organic mono and dipercarboxylic acids selected from the group consisting of imidopercarboxylic acids, dodecanebis(peroxoic) acid or imidopercarboxylic acids, 6-phthalimidopercaproic acid (6-phthalimidoperhaxanoic acid, PAP), and/or that the organic percarboxylic acid has a melting point at atmospheric pressure above 100° C.

9. A storage stable dispersion comprising stabilized percarboxylic acid and at least one surfactant, wherein in said dispersion the halide ion content is minimized in order to reduce the decomposition and/or solubility of the stabilized percarboxylic acid in the dispersion relative to percarboxylic acid that is not stabilized.

10. The dispersion according to claim 9, wherein the percarboxylic acid is at least one imidopercarboxylic acid.

11. A storage stable dispersion comprising surfactants and particulate percarboxylic acids which are solid at room temperature, wherein the dispersion is adjusted in such a way
that the total content of halide ions, particularly chloride and/or bromide, based on the continuous dispersion phase, does not exceed 100 ppm and/or
that the dispersion has a pH of 3.5 to 7 and/or
that the dispersion, at least essentially, comprises no surfactants in active form, in particular, wherein the total active surfactant content in the continuous phase of the dispersion is less than 5%, based on the continuous dispersion phase.

12. The dispersion according to claim 9, wherein the dispersion comprises at least one chelating agent and/or the dispersion comprises at least one catalase and/or at least one peroxidase and/or at least one antioxidant and/or the dispersion comprises at least one water-miscible solvent, in which the organic polycarboxylic acid, particularly imidopercarboxylic acid, is poorly soluble.

13. The dispersion according to claim 9, wherein the dispersion has a low niosurfactant/charged surfactant ratio.

14. The dispersion according to claim 9, wherein the percarboxylic acids are additionally provided with at least one shell or are deposited in at least one matrix.

15. The dispersion according to claim 9, wherein the particle size of the organic percarboxylic acid is 10 to 3,000 μm.

16. The dispersion according to claim 9, wherein the content of organic percarboxylic acids, based on the dispersion, is 0.1 to 30 wt. %.

17. The dispersion according to claim 9, wherein the organic percarboxylic acids are organic mono and dipercarboxylic acids, selected from the group consisting of dodecanebis(peroxoic) acid, imidopercarboxylic acids, 6-phthalimidopercaproic acid (6-phthalimidoperhexanoic acid, PAP), and/or that the organic percarboxylic acids have a melting point at atmospheric pressure above 100° C.

18. A washing or cleaning agent composition, tooth-care product, hair colorant or decolorizing or bleaching agent, comprising the storage stable dispersion of claim 9.

19. The washing or cleaning agent according to claim 18, comprising:
(i) at least one organic percarboxylic acid, in amounts of 0.1 to 30 wt. % and/or
(ii) cationic and/or anionic surfactants in amounts of 0 to 30 wt. %, and/or non-ionic surfactants, in amounts of 0 to 30 wt. %; and/or
(iii) optionally electrolytes, in particular, selected from the group consisting of inorganic and/or organic salts, phosphate, citrate and/or sulfate, and sodium sulfate, in amounts of 5 to 30 wt. %; and/or
(iv) optionally chelating agents, selected from the group of quinoline and/or its salts, alkali metal polyphosphonates, picolinic acid and dipicolinic acid, mono- or polyphosphonic acids, 1-hydroxyethylidene-1,1-diphosphonic acid (HEDP), ethylene diamine tetraacetic acid (EDTA), diethylene triamine penta(methylenephosphonic acid) (DTPMP), azacycloheptane diphosphonate (AH), nitrilotriacetic acid (NTA), citrate and/or short chain dicarboxylic acids, in amounts of 0 to 10 wt. %; and/or
(v) optionally enzymes selected from the group consisting of proteases, amylates, cellulases and/or lipases, and/or enzyme stabilizers, in amounts of 0 to 10 wt. %; and/or
(vi) optionally builders, such as selected from the group consisting of fatty acids, saturated and/or branched fatty acids, with a melting point below 30° C., and/or citric acid and/or citrate in amounts of 0 to 15 wt.; and/or
(vii) optionally fragrances, in amounts of 0 to 5 wt. %; and/or
(viii) optionally auxiliaries, such as defoamers, pH regulators, rheology modifiers (thickeners), solvents, colorants; and/or
(ix) optionally brighteners; and/or
(x) water;
wherein all the specified weights are based on the washing or cleaning agent.

20. A process of preparing washing or cleaning agent, particularly liquid washing or cleaning agent compositions, tooth-care products, hair colorants or decolorizing or bleaching agent comprising the step of adding to the preparation the storage stable dispersion of claim 9.
